(19) United States
(12) Patent Application Publication
(10) Pub. No.: US 2008/0182575 A1
(43) Pub. Date: Jul. 31, 2008

(54) IMS RELIABILITY MECHANISMS

(75) Inventors: Jose Miguel M. Torres, Madrid (ES); Miguel Angel Munoz de la Torre, Madrid (ES); Luis F. Velarde, Alcobendas (ES)

Correspondence Address: MOTOROLA, INC., 1303 EAST ALGONQUIN ROAD, IL01/3RD, SCHAUMBURG, IL, 60196, US

(73) Assignee: MOTOROLA, INC., Schaumburg, IL (US)

(21) Appl. No.: 11/668,562

(22) Filed: Jan. 30, 2007

(51) Int. Cl. H04Q 7/20

(52) U.S. Cl. 455/435.1

(57) ABSTRACT

A method and information processing system provide reliability in an IP multimedia subsystem network. The method includes monitoring a S-CSCF (210) for its availability. The method also includes determining, based on the monitoring, that the S-CSCF (210) is unavailable. A wireless device (106) registered with the S-CSCF (210) is notified that the S-CSCF (210) is unavailable. Optionally, the wireless device (106) is notified to re-register with a new S-CSCF.

### FIELD OF THE INVENTION

The present invention generally relates to the field of wireless communications, and more particularly relates to providing reliability within an Internet Protocol (“IP”) Multimedia Subsystem Network when a serving call session control function component becomes unavailable.

### BACKGROUND OF THE INVENTION

Many current wireless communications systems are providing fixed and mobile multimedia services to their subscribers by implementing an IP multimedia subsystem (“IMS”). IMS allows a home network to provide its subscribers services independent of the subscribers' location and access technology. However, IMS does not currently provide reliability mechanisms for its components. For example, a main component of IMS is the Serving Call Session Control Function (“S-CSCF”). The S-CSCF is a Session Initiation Protocol (“SIP”) server that performs session control. The S-CSCF communicates with a home subscriber server (“HSS”) for downloading an uploading user profiles and handles SIP registrations. If the S-CSCF goes down (i.e., becomes unavailable) a subscriber device cannot communicate using the IMS. Currently, mechanisms do not exist in the IMS to notify the subscriber device that an S-CSCF is unavailable or to automatically re-assign the device to a new S-CSCF. The subscriber device is blocked from sending or receiving calls until the registration time expires.

Therefore a need exists to overcome the problems with the prior art as discussed above.

### SUMMARY OF THE INVENTION

Briefly, in accordance with the present invention, disclosed is a method on an information processing system for providing reliability in an IP multimedia subsystem network. The method includes monitoring an S-CSCF for its availability. The method also includes determining, based on the monitoring, that the S-CSCF is unavailable. A wireless device registered with the S-CSCF is notified that the S-CSCF is unavailable.

In another embodiment, a method on a wireless device for providing reliability in an IP multimedia subsystem network is disclosed. The method includes monitoring an S-CSCF for its availability. The method also includes determining, based on the monitoring, that the S-CSCF is unavailable. The wireless device registers with a new S-CSCF based on determining that the S-CSCF is unavailable.

In yet another embodiment, an information processing system for providing reliability in an IP multimedia subsystem network is disclosed. The information processing system includes a memory and a processor that is communicatively coupled to the memory. The information processing system also includes an IP multimedia subsystem reliability module that is communicatively coupled to the memory and the processor. The IP multimedia subsystem reliability module is for monitoring an S-CSCF for its availability. The IP multimedia subsystem reliability module is also for determining, based on the monitoring, that the S-CSCF is unavailable. A wireless device registered with the S-CSCF is notified that the S-CSCF is unavailable.

### BRIEF DESCRIPTION OF THE DRAWINGS

The accompanying figures where like reference numerals refer to identical or functionally similar elements throughout the separate views, and which together with the detailed description below are incorporated in and form part of the specification, serve to further illustrate various embodiments and to explain various principles and advantages all in accordance with the present invention.

FIG. 1 is block diagram illustrating a wireless communication system according to an embodiment of the present invention;

FIG. 2 is a block diagram illustrating a more detailed view of the wireless communication system of FIG. 1 according to an embodiment of the present invention;

FIG. 3 is a signaling diagram for detecting the availability of an S-CSCF at a P-CSCF according to an embodiment of the present invention;

FIG. 4 is signaling diagram for detecting the availability of an S-CSCF at a P-CSCF according to another embodiment of the present invention;

FIG. 5 is a signaling diagram for detecting the availability of an S-CSCF at a wireless device according to embodiment of the present invention;

FIG. 6 is signaling diagram for detecting the availability of an S-CSCF at a wireless device according to another embodiment of the present invention;

FIG. 7 is a block diagram illustrating an information processing system according to an embodiment of the present invention;

FIG. 8 is a block diagram illustrating a wireless communication device according to an embodiment of the present invention;

FIG. 9 is an operational flow diagram illustrating a process at a P-CSCF for detecting the availability of an S-CSCF according to an embodiment of the present invention;

FIG. 10 is an operational flow diagram illustrating another process at a P-CSCF for detecting the availability of an S-CSCF according to an embodiment of the present invention;

FIG. 11 is an operational flow diagram illustrating a process at a wireless device for detecting the availability of an S-CSCF according to an embodiment of the present invention; and

FIG. 12 is an operational flow diagram illustrating another process of a wireless device detecting the availability of an S-CSCF according to an embodiment of the present invention.

### DETAILED DESCRIPTION OF THE INVENTION

As required, detailed embodiments of the present invention are disclosed herein; however, it is to be understood that the disclosed embodiments are merely examples of the invention, which can be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure. Further, the terms and phrases used herein are not intended to be limiting; but rather, to provide an understandable description of the invention.

The terms “a” or “an”, as used herein, are defined as one or more than one. The term plurality, as used herein, is defined as two or more than two. The term another, as used herein, is defined as at least a second or more. The terms including and/or having, as used herein, are defined as comprising (i.e., open language). The term coupled, as used herein, is defined as connected, although not necessarily directly, and not necessarily mechanically.

The term wireless communication device is intended to broadly cover many different types of devices that can wirelessly receive signals, and optionally can wirelessly transmit signals, and may also operate in a wireless communication system. For example, and not for any limitation, a wireless communication device can include any one or a combination of the following: a cellular telephone, a mobile phone, a smartphone, a two-way radio, a two-way pager, a wireless messaging device, a laptop/computer, automotive gateway, residential gateway, and the like. A multi-mode wireless device is intended to broadly cover any wireless device that can communicate using more than one communication service such as Push-to-Talk (“PTT”)/Push-to-Talk over Cellular (“PoC”), cellular, Voice Over IP (“VoIP”), data packet transfer, or the same type of communication service but on different networks.

An advantage of the foregoing embodiments of the present invention is that the availability of an S-CSCF is monitored. This allows for a wireless device registered with an out-of-service S-CSCF to re-register with another S-CSCF and continue service. Generally, when an S-CSCF goes down, a wireless device does not regain service until its registration period expires. The present invention allows for a wireless device to be notified when the S-CSCF is unavailable to it can immediately re-register with a new S-CSCF.

Exemplary Wireless Communications System

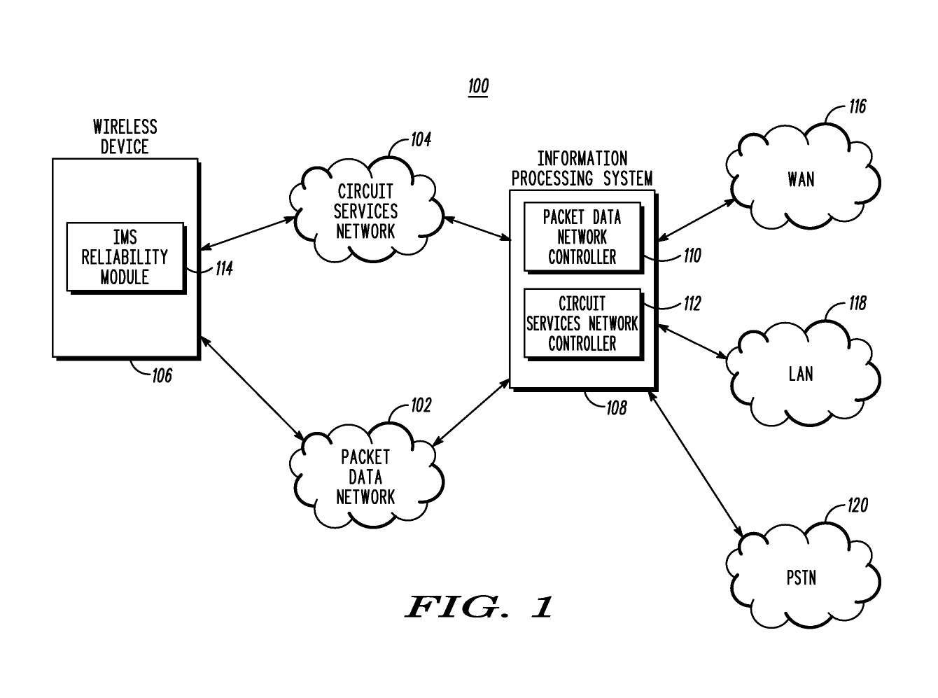

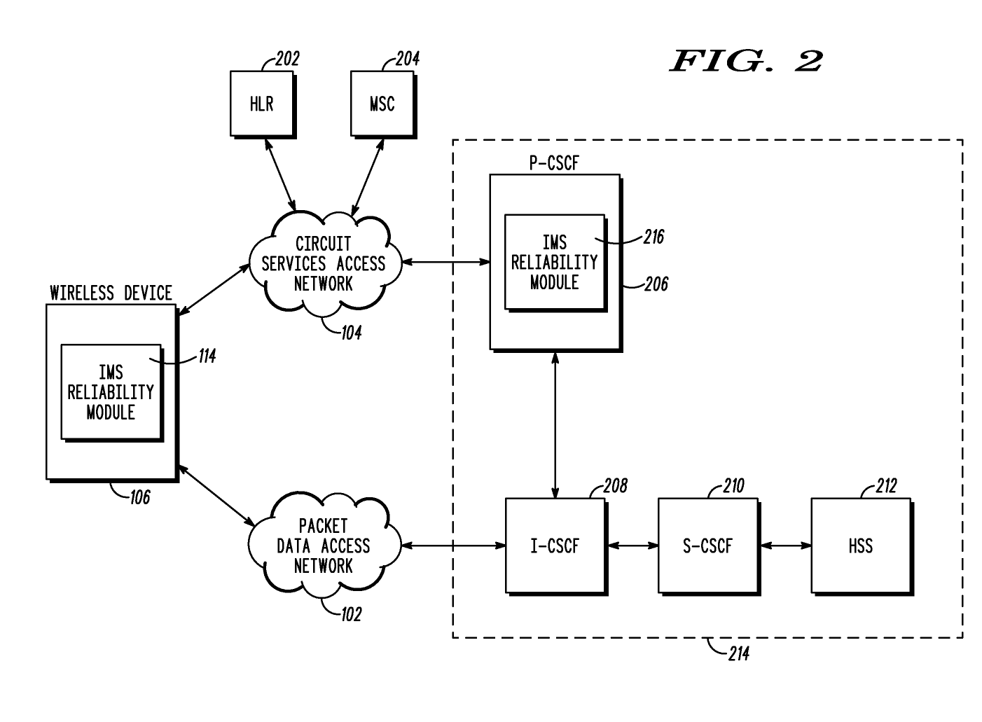

According to an embodiment of the present invention, as shown in FIG. 1, an exemplary wireless communication system 100 is illustrated. FIG. 1 shows the wireless communications system 100 including a packet data network 102 and a circuit services network 104 that each connects a wireless device 106 to an information processing system 108. Each of these networks 102, 104 is coupled to an Internet Protocol multimedia subsystem (“IMS”) network as discussed below with respect to FIG. 2. It should be noted that the packet data network 102 and the circuit services network 104 can be in separate systems as shown in FIG. 2, where one network is the home network of the wireless device 106 and the other network is a visited network. Also, in one embodiment, the wireless communications system 100 only includes one of the packet data network 102 and the circuit services network 104.

The wireless device 106 includes an IMS reliability module 114. The wireless device 106 and the IMS reliability module 114 are discussed in greater detail below. In one embodiment, the packet data network 102 is an Internet Protocol (“IP”) connectivity network, which provides data connections at much higher transfer rates then a traditional circuit services network. The packet data network 102 can comprise any one or more of an Evolution Data Only (“EV-DO”) network, a General Packet Radio Service (“GPRS”) network, a Universal Mobile Telecommunications System (“UMTS”) network, an 802.11 network, an 802.16 (WiMax) network, Ethernet connectivity, dial-up modem connectivity, or the like.

The circuit services network 104, in one embodiment, provides, among other things, voice services to the wireless device 106. The packet data network 102 and the circuit services network 104 can each comprise a mobile text messaging device network, a pager network, or the like. Text messaging standards such as Short Message Service (“SMS”), Enhanced Messaging Service (“EMS”), Multimedia Messaging Service (“MMS”), and the like are also included in the networks 102, 104.

Further, the communications standard of the packet data network 102 and the circuit services network 104 can comprise any one or more of Code Division Multiple Access (“CDMA”), Time Division Multiple Access (“TDMA”), Global System for Mobile Communications (“GSM”), General Packet Radio Service (“GPRS”), Frequency Division Multiple Access (“FDMA”), Orthogonal Frequency Division Multiplexing (“OFDM”), or the like. The networks 102, 104 also allow for push-to-talk over cellular (PoC) communications between capable wireless communication devices.

The packet data network 102 and the circuit services network 104 support any number of wireless devices such as wireless device 106. The support of the networks 102, 104 includes support for mobile telephones, smartphones, text messaging devices, handheld computers, wireless communication cards, pagers, beepers, or the like. A smartphone is a combination of 1) a pocket PC, handheld PC, palm top PC, or Personal Digital Assistant (“PDA”), and 2) a mobile telephone. More generally, a smartphone can be a mobile telephone that has additional application processing capabilities.

The information processing system 108 maintains and controls the packet data network 102 and the circuit services network 104. For example, the information processing system 108 includes, in one embodiment, a packet data network controller 110 and a circuit services network control 112 for maintaining each network 102, 104, respectively. Additionally, the information processing system 108 communicatively couples the wireless device 106 to a wide area network 116, a local area network 118, and a public switched telephone network 120 through the packet data network 102 and the circuit services network 104. Each of these networks 116, 118, 120 has the capability of sending data, for example, a multimedia text message, to the wireless device 106.

Exemplary System for Providing IMS Reliability

FIG. 2 is a block diagram depicting the wireless communication system 100 of FIG. 1 from another perspective, that is, an IP multimedia subsystem (“IMS”) perspective. In FIG. 2, the packet data network 102 and the circuit services network 102 are depicted as two separate networks. In the example of FIG. 2, the packet data network 102 is the home network of the wireless device 106 and the circuit services network is a visited network in which the wireless device 106 is roaming. It should be noted that FIG. 1 and FIG. 2 are only illustrative examples and do not limit the present invention in any way. The present invention is applicable to any wireless communication system configuration where a wireless device 106 is accessing an IMS network.

As described above, the wireless communication system 100 comprises one or more wireless devices 106 that are communicatively coupled to the packet data network 102 and the circuit services network 104. The packet data network 102 and the circuit services network 104 are each further coupled to an IMS network 214 that includes a Proxy Call Session Control Function (“P-CSCF”) component 206 that is communicatively coupled to an interrogating call session control function (“I-CSCF”) 208, a Serving Call Session Control Function (“S-CSCF”) 210 communicatively coupled to the I-CSCF, and a register 212, such as an HSS, communicatively coupled to the S-CSCF. It should be noted that other components may reside within the IMS network 214 as should be known to those of ordinary skill in the art.

In one embodiment, a home location register (“HLR”) 202 and a mobile switching center (“MSC”) 204, along with other components that are not shown, are communicatively coupled to the circuit services network 104. The HLR 202 helps route calls, SMS messages, and the like and ensures security. The HLR 202 includes an authentication center (not shown). The authentication center (not shown), comprises a database including information associated with a wireless device subscribing to the circuit services network 104. Subscriber information, in one embodiment, comprises access right(s) and/or a service(s) subscribed to by the wireless device 106.

The MSC 204 comprises a location of a Digital Access and Cross Connect System (“DACS”) in the wireless communication system 100. In one embodiment, the MSC 204 manages communications between the wireless device 106 and the PSTN 122 and controls switching functions. The MSC 204 provides, among other things, circuit-switched calling and mobility management. For example, the MSC provides SMS, voice, and data and fax services. The MSC 204 can be a gateway MSC, which interfaces with the PSTN 122. A gateway MSC also determines which visited MSC a current recipient subscriber is currently located with. All calls between wireless devices and the PSTN 122 are routed through the gateway MSC. The MSC 204 can also be a visited MSC, which is the MSC where a wireless device is currently located. It should be noted that other network components besides the HLR 202 and the MSC 204 are communicatively coupled to the circuit services network 104 as would be understood to those of ordinary skill in the art.

In one example, the HLR 202 comprises a signaling system 7 (“SS7”) database. SS7 is a set of telephony signaling protocols used to achieve connection control in a telephony network. In the example of FIG. 2, the wireless device 106 is trying to access the IMS network 214 of its home network, that is, the packet network 102, while the wireless device 106 is roaming within the visited network, that is, the circuit services network 104. However, as discussed above, the present invention is also applicable to a wireless device 106 accessing an IMS network from its home network. IMS is a Next Generation Networking architecture for mobile and fixed IP services. IMS uses a Voice-over-IP implementation and runs over the standard IP. The wireless device 106 can connect to the IMS network using different methods, which all use standard IP. For example, when a wireless device 106 wants to access the packet data network 102, the wireless device 106 registers with the IMS network. The basic functions of an IMS network should be known to those or ordinary skill in the art.

In one embodiment of the present invention, the P-CSCF 206, I-CSCF 208, S-CSCF 210, and HSS 212 are part of a session initiation protocol (“SIP”) network. The SIP network is used for establishing instant messaging, telephone calls, and other real-time communications over the Internet. The SIP network allows for IP telephony services to be integrated in a wireless communication system. The HSS 212 comprises a database including profiles associated with each wireless device 106 registered with the IMS 214. A profile, for example, includes subscription related information. The HSS 210 also performs authentication and authorization of the wireless device 106. The HSS 212 also provides information about the physical location of the wireless devices to requesting entities. The HSS 212 also includes information to identify each registered wireless device, such as the wireless device 106, such as a telephone uniform resource identifier (“tel-URI”) and/or a SIP uniform resource identifier (“SIP-URI”). A tel-URI, for example, is the telephone number assigned to the wireless device. The P-CSCF 206, the I-CSCF 208, and the S-CSCF 210 are SIP servers (proxies) that are used to process SIP signaling packets in an IMS network.

The P-CSCF 206 is a SIP proxy and is the first contact point for a wireless device, such as wireless device 106, registered in the IMS network. In one embodiment, the wireless device 106 locates its respective P-CSCF 206 via a dynamic host configuration protocol (“DHCP”). The wireless device 106 is assigned to a specific P-CSCF 206 for the duration of the device's subscription to the IMS network. All signaling messages are intercepted by the P-CSCF 206, allowing the P-CSCF to inspect the messages. The P-CSCF 206 authenticates the wireless device 106 and is trusted by the other IMS components, which therefore do not perform further authentication of the wireless device 106. For example, after successful registration of the wireless device 106 with the S-CSCF 210, security keys are sent to the P-CSCF 206, which allows the P-CSCF to setup a security association with the wireless device 106. The P-CSCF 206 can authenticate subsequent messages allowing the other network entities such as the I-CSCF 208 and the S-CSCF 210 to trust the messages. Other functions of the P-CSCF 206 should be known to those of ordinary skill in the art.

As stated above, the I-CSCF 208 is also a SIP proxy. The IP address of the I-CSCF 208 is published in the domain name system (“DNS”) of the domain. This allows for remote servers, for example, the P-CSCF 206 when residing in a visited domain or the S-CSCF 210 when residing in a foreign domain, to locate the I-CSCF 208. The remote servers use the I-CSCF 208 as an entry point for all SIP packets to the domain where the I-CSCF is located. The I-CSCF 208 retrieves the location of the wireless device 106 so that a SIP request associated with the device 106 can be routed to the S-CSCF 210 assigned to the device 106. The I-CSCF is the IMS entry point from other external networks.

The S-CSCF 210 is a SIP server, but also performs session control. The S-CSCF 210 is located in the home network of the wireless device 106. The S-CSCF 210 retrieves device profiles from the HSS 212. The S-CSCF 210 also handles SIP registrations which allows the S-CSCF 210 to bind the location of the wireless device 106 (e.g., the IP address of the device) and the SIP address. The S-CSCF 210 can intercept all of the signaling messages in the IMS so that it can inspect each message.

The S-CSCF 210 also determines to which application server(s) to forward the SIP message associated with the wireless device 106 so that the services subscribed to by the device 106 can be provided. Other functions of the S-CSCF 210 should be known to those of ordinary skill in the art. Although the P-CSCF 206, I-CSCF 208, S-CSCF 210, and HSS 212 are shown as separate components, each respective component can reside on the same or separate information processing system. Additionally, there can be multiple instances of a same component in the IMS network 214. For example, two or more S-CSCFs 210 can exist within the IMS network 214. The information processing system 108 comprises at least the P-CSCF 206 of the IMS network 214; however, in various embodiments of the present invention, the information processing system 108 may further include one or more of the I-CSCF 208, the S-CSCF 210, and the HSS 212 of the IMS network and/or additional network components which are not shown for simplicity.

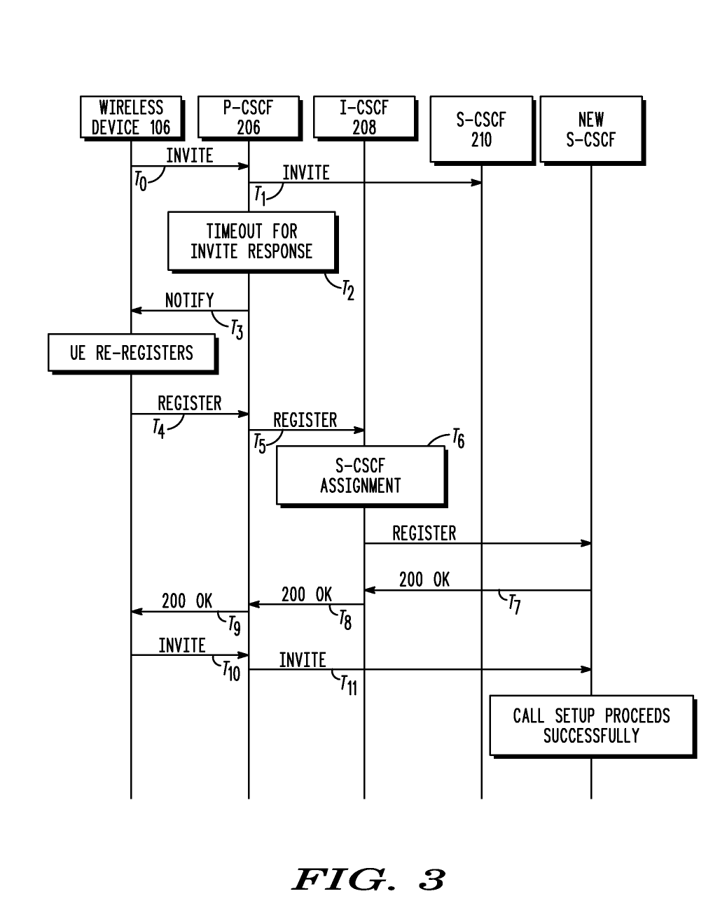

In various situations the S-CSCF 210 can become unavailable (e.g., goes out of service). When the S-CSCF 210 is unavailable, the wireless device 106 registered in the S-CSCF 210 (there can be more than one S-CSCF in an IMS network 214) does not notice that the S-CSCF is down until the wireless device's registration timer expires. Therefore, the wireless device 106 and/or the P-CSCF 206 can each include an IMS reliability module 114, 216, respectively, to detect an unavailable S-CSCF 210. The present invention is not limited to both the wireless device 106 and the P-CSCF 206 including an IMS reliability module 114, 216. The IMS reliability module 114, 216, in one embodiment, triggers re-registration of the wireless device 106 with a new S-CSCF when its current S-CSCF becomes unavailable. Therefore, the wireless device 106 does not need to wait until its registration time expires until it can regain service. The following signaling diagrams discussed with respect to FIGS. 3-6 illustrate various embodiments of detecting and notifying a wireless device of an unavailable S-CSCF and its re-registration with a new S-CSCF.

Signaling Diagram For P-CSCF IMS Reliability Module: Per Invite Received

FIG. 3 is a signaling diagram illustrating a triggering of a re-registration of the wireless device 106 when its current S-CSCF is unavailable according to an embodiment of the present invention. In the example of FIG. 3, the IMS reliability module 216 included in the P-CSCF 216 determines that the S-CSCF 210 is unavailable.

The wireless device 106 at To initiates a call to another communication device by sending an initial INVITE message to the P-CSCF 206. At T₁, the P-CSCF 206 forwards the INVITE message based on route header information included in the INVITE to the corresponding S-CSCF 210. The P-CSCF 206 waits for a 100 message (i.e., a Trying response) from the S-CSCF 210. However, a response is not received if the S-CSCF 210 is out of service. At T₂, the waiting period for the 100 message times out and the IMS reliability module 216 of P-CSCF 206 determines that the S-CSCF 210 is out of service. At T₃, the P-SCSF 206, based on the determination made by the IMS reliability module 216, notifies the wireless device 206 that the S-CSCF 210 is out of service. The P-CSCF 206 also sends a request to the wireless device 106 to re-register with another S-CSCF. For example, the P-CSCF can send a network initiated de-registration message to the wireless device 106 so that the wireless device de-registers from the out of service S-CSCF 210 and re-registers with another S-CSCF.

The wireless device 106, at T₄, re-registers with another S-CSCF by sending a REGISTER request to the P-CSCF 206, which forwards the request to the I-CSCF 208 at T₅. A new S-CSCF at T₆ is assigned to the wireless device 106 where a REGISTER message is sent from the I-CSCF 208 to the new S-CSCF. The new S-CSCF at T₇ sends a 200 OK message back to the I-CSCF 208, which then sends the 200 OK message at T₈ to the P-CSCF 206. The P-CSCF 206 sends to the wireless device, and the wireless device 106 receives, the 200 OK message at T₉. The wireless device 106 can then try the call again by sending an INVITE message at T₁₀ to the P-CSCF 206. The P-CSCF 206, at T₁₁, forwards the INVITE message to the new S-CSCF, where the call setup proceeds successfully.

In another embodiment of the present invention illustrated in FIG. 3, the P-CSCF 206 can perform the re-registration for the wireless device 106. In this embodiment, the P-CSCF 206 initiates a new registration for the wireless device 106 by conveying a new registration (re-reg) to the I-CSCF 208. In response to the triggering of a new registration, the I-CSCF 208 assigns a new S-CSCF to the wireless device 106 and provides updated service routing information, that is, a new Service-Route header, that identifies the new S-CSCF, to the P-CSCF 206, preferably in the 200 OK message conveyed by the I-CSCF to the P-CSCF. The P-CSCF 206, from this point forward, replaces the Route header received from the wireless device 106 with the new Service-Route information received for the new S-CSCF.

Signaling Diagram for P-CSCF IMS Reliability Module: Periodic Ping to S-CSCF

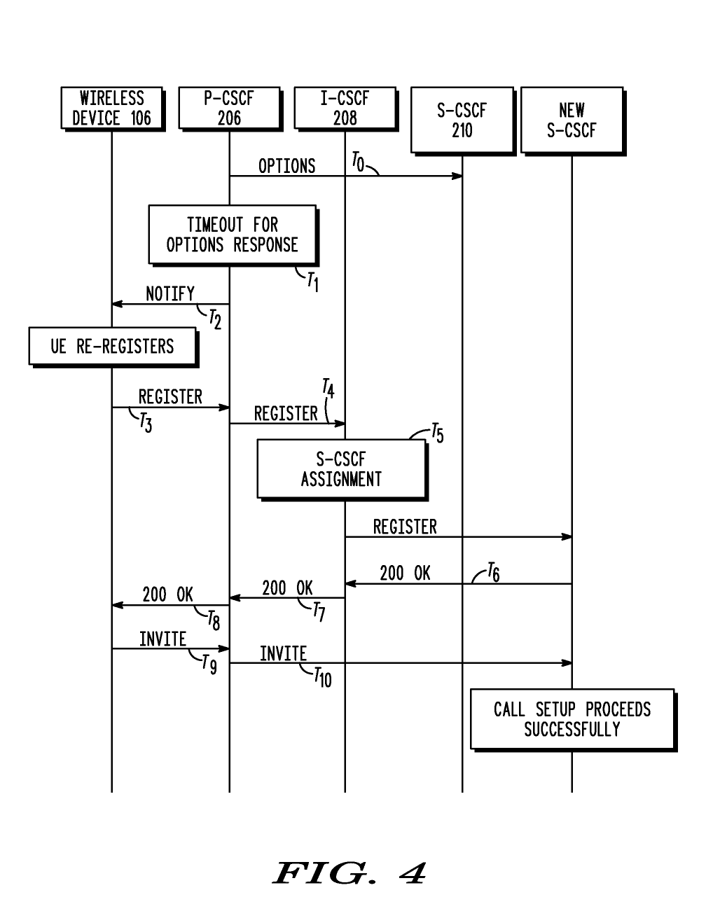

FIG. 4 is a signaling diagram illustrating a triggering of a re-registration of the wireless device 106 when its current S-CSCF is unavailable according to another embodiment of the present invention. In FIG. 4, the IMS reliability module 216 included in the P-CSCF 206 determines that the S-CSCF 210 is unavailable. The P-CSCF 206 monitors the availability of S-CSCF 210, via the IMS reliability module 216, by sending an OPTION message to check S-CSCF availability at T₀. The OPTION message is a typical SIP keep alive mechanism, which is sent to the S-CSCF 210 at given intervals. If the S-CSCF 210 is not available, the P-CSCF 206 does not receive an OPTION response back at T₁. Based on the failure to receive an OPTION response, that is, when a corresponding waiting period times out, the IMS reliability module 216 then determines that the S-CSCF 210 is not available.

At T₂, the P-SCSF 206, based on the determination made by the IMS reliability module 216, notifies the wireless device 106 that the S-CSCF 210 is out of service. The P-CSCF 206 also sends a request to the wireless device 106 to re-register with another S-CSCF. For example, the P-CSCF can send a network initiated de-registration message to the wireless device 106 so that the wireless device de-registers from the out of service S-CSCF 210 and re-registers with another S-CSCF.

The wireless device 106, at T₃, re-registers with another S-CSCF by sending a REGISTER request to the P-CSCF 206, which forwards the request to the I-CSCF 208 at T₄. The I-CSCF 208 assigns a new S-CSCF at T₅ to the wireless device 106 and sends a REGISTER message to the new S-CSCF. The new S-CSCF at T₆ sends a 200 OK message back to the I-CSCF 208, which then sends the 200 OK message at T₇ to the P-CSCF 206. The P-CSCF sends the 200 OK message to, and the message is received by, the wireless device 106 at T₈. The wireless device 106 can then try the call again by sending an INVITE message at T₉to the P-CSCF 206. The P-CSCF 206 forwards the INVITE message at T₁₀ to the new S-CSCF, where the call setup proceeds successfully.

In another embodiment of the present invention illustrated in FIG. 4, the P-CSCF 206 can perform the re-registration for the wireless device 106. In this embodiment, the P-CSCF 206 initiates a new registration for the wireless device 106 by conveying a new registration (re-reg) to the I-CSCF 208. In response to the triggering of a new registration, the I-CSCF 208 assigns a new S-CSCF to the wireless device 106 and provides updated service routing information, that is, a new Service-Route header, that identifies the new S-CSCF, to the P-CSCF 206, preferably in the 200 OK message conveyed by the I-CSCF to the P-CSCF. The P-CSCF 206 updates the Service-Route for the wireless device 106. The P-CSCF 206, from this point forward, replaces the Route header received from the wireless device 106 with the new Service-Route information received from the new S-CSCF.

Signaling Diagram for Wireless Device IMS Reliability Module: Periodic Ping to S-CSCF

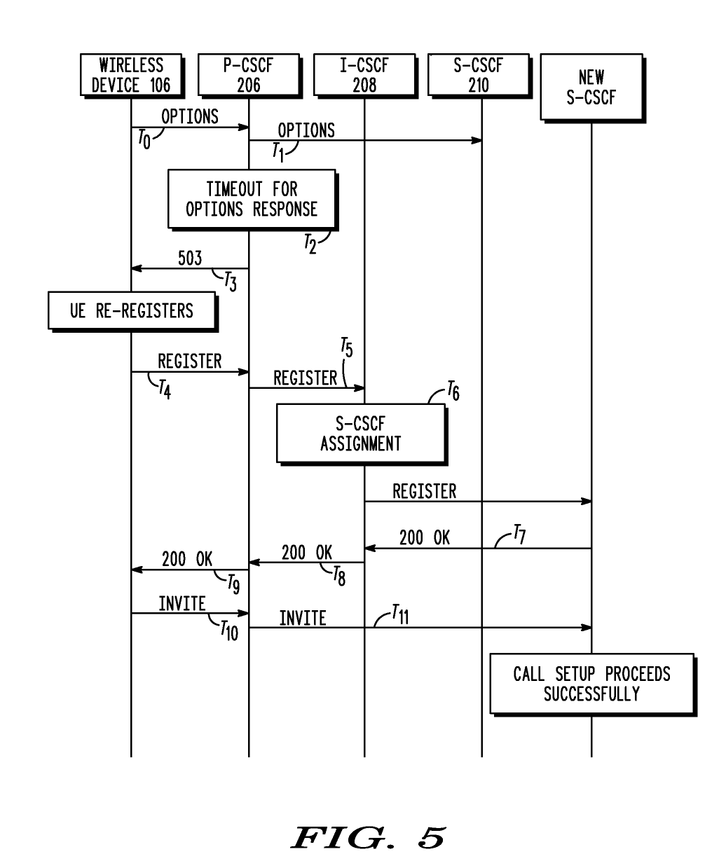

FIG. 5 is a signaling diagram illustrating a triggering of a re-registration of the wireless device 106 when its current S-CSCF is unavailable according to another embodiment of the present invention. In FIG. 5, the IMS reliability module 114 included in the wireless device 106 determines that the S-CSCF 210 is unavailable. The wireless device 106 monitors the availability, via the IMS reliability module 114, by sending an OPTION message to check S-CSCF availability at To. The OPTION message is a typical SIP keep alive mechanism, which is sent to the S-CSCF 210 at given intervals. The P-CSCF 206 at T₁ receives the OPTION message from the wireless device 106 and forwards it to the S-CSCF 210. If the S-CSCF 210 is not available, the P-CSCF 206 does not receive an OPTION response back at T₂. Based on the failure to receive an OPTION response, that is, when a corresponding waiting period times out, the P-CSCF 206 at T₃ then sends a 503 message to the wireless device 106. In response to receiving the 503 message, the IMS reliability module 114 of the wireless device 106 determines that the S-CSCF 210 is not available.

At T₄, the wireless device 106, based on the determination made by the IMS reliability module 114, re-registers with another S-CSCF by sending a REGISTER request to the P-CSCF 206, which forwards the request to the I-CSCF 208 at T₅. The I-CSCF 208 assigns a new S-CSCF at T₆ to the wireless device 106 and sends a REGISTER message to the new S-CSCF. The new S-CSCF at T₇ sends a 200 OK message back to the I-CSCF 208, which then sends the 200 OK message at T₈ to the P-CSCF 206. The P-CSCF sends to the wireless device 106, and the wireless device receives, the 200 OK message at T₉. The wireless device 106 can then try the call again by sending an INVITE message at T₁₀ to the P-CSCF 206. The P-CSCF 206 forwards the INVITE at T₁₁ message to the new S-CSCF, where the call setup proceeds successfully.

Signaling Diagram for Wireless Device IMS Reliability Module: Error on Invite Message

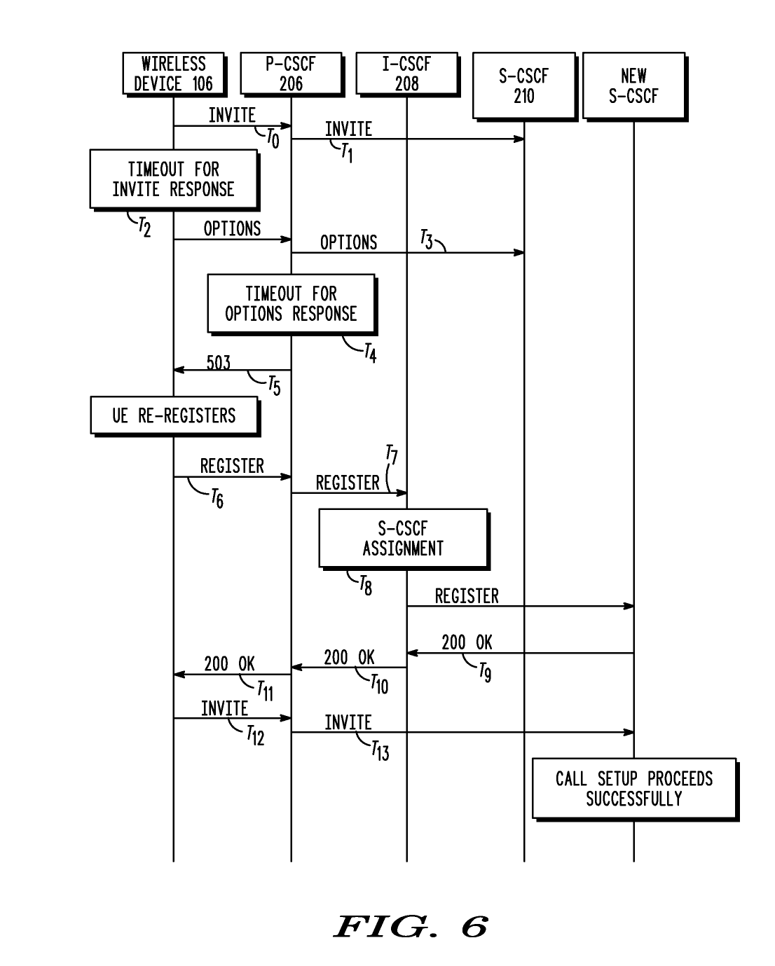

FIG. 6 is a signaling diagram illustrating a triggering of a re-registration of the wireless device 106 when its current S-CSCF is unavailable according to another embodiment of the present invention. In FIG. 6, the IMS reliability module 114 included in the wireless device 106 determines that the S-CSCF 210 is unavailable. The wireless device 106 at T₀ initiates a call to another communication device by sending an initial INVITE message to the P-CSCF 206. At T₁, the P-CSCF 206 forwards the INVITE message based on route header information included in the INVITE to the corresponding S-CSCF 210. The wireless device 106 waits for the 100 message (i.e., Trying response) from the S-CSCF 210. If the wireless device does not receive a response to the INVITE message from the S-CSCF 210, for example, if at T₂, a waiting period for the 100 message times out, the wireless device 106 sends an OPTIONS message to the S-CSCF 210. The P-CSCF 206 receives the OPTIONS message at T₃ and forwards the OPTIONS message to the S-CSCF 210.

If the S-CSCF is unavailable, the P-CSCF 206 at T₄ does not receive a response to the OPTIONS message from the S-CSCF and a waiting period for the OPTIONS response times out. The P-CSCF 206 at T₅ then sends a 503 message to the wireless device 106. In response to receiving the 503 message, the IMS reliability module 114 of the wireless device 106 determines that the S-CSCF 210 is not available. At T₆, the wireless device 106, based on the determination made by the IMS reliability module 114, re-registers with another S-CSCF by sending a REGISTER request to the P-CSCF 206, which forwards the request to the I-CSCF 208 at T₇. The I-CSCF 208 assigns a new S-CSCF at T₈ to the wireless device 106 and sends a REGISTER message to the new S-CSCF. The new S-CSCF at T₉ sends a 200 OK message back to the I-CSCF 208, which then sends the 200 OK message at T₁₀ to the P-CSCF 206. The P-CSCF 206 sends to the wireless device 106, and the wireless device receives, the 200 OK message at T₁₁. The wireless device can then try the call again by sending an INVITE message at T₁₂ to the P-CSCF 206. The P-CSCF 206 forwards the INVITE at T₁₃ message to the new S-CSCF, where the call setup proceeds successfully.

Information Processing System

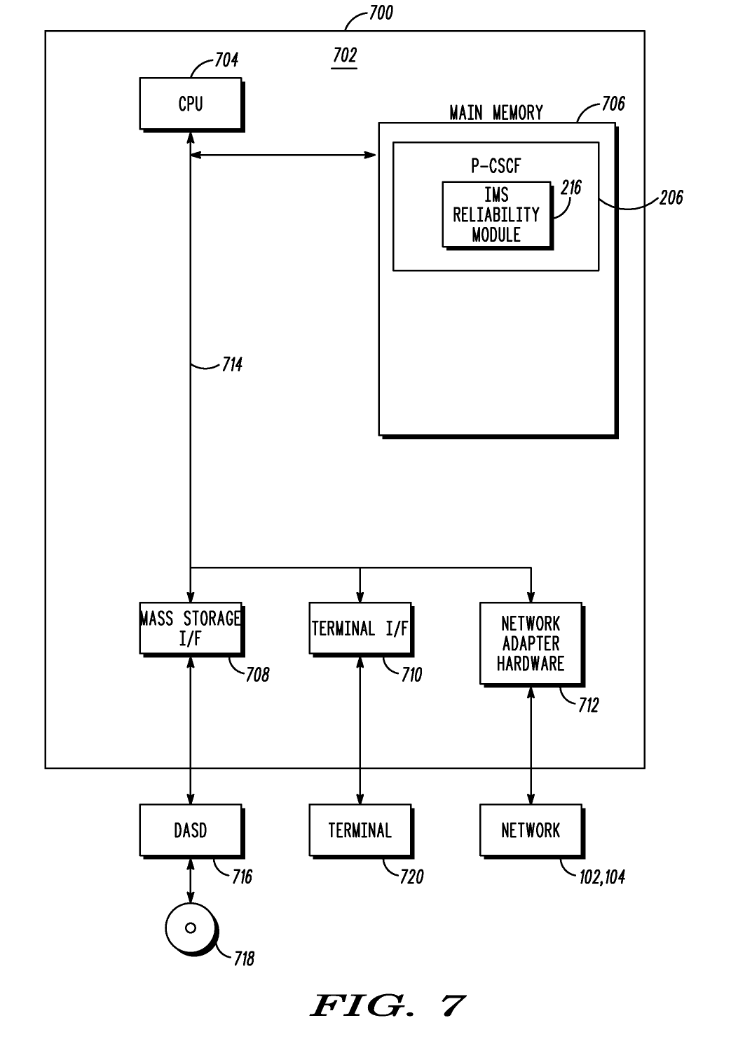

FIG. 7 is a block diagram illustrating a detailed view of an information processing system 700, such as information processing system 108, according to an embodiment of the present invention. The information processing system 700 includes a P-CSCF, such as the P-CSCF 206. The information processing system 700 may also include additional network components which are not shown for simplicity. The information processing system 700 is based upon a suitably configured processing system adapted to implement the exemplary embodiment of the present invention. Any suitably configured processing system is similarly able to be used as the information processing system 700 by embodiments of the present invention. For example, a personal computer, workstation, or the like, may be used.

The information processing system 700 includes a computer 702. The computer 702 has a processor 704 that is connected to a main memory 706, a mass storage interface 708, a terminal interface 710, and network adapter hardware 712. A system bus 714 interconnects these system components. The mass storage interface 708 is used to connect mass storage devices such as data storage device 716 to the information processing system 700. One specific type of data storage device is a computer readable medium such as a CD drive, which may be used to store data to and read data from a CD 718. Another type of data storage device is a data storage device configured to support New Technology File System (“NTFS”) operations, UNIX operations, or the like.

In one embodiment, the main memory 706 includes the P-CSCF, such as the P-CSCF 206. The P-CSCF includes an IMS reliability module, such as IMS reliability module 216, which detects when an S-CSCF, such as S-CSCF 210, has become unavailable, as discussed above. Although illustrated as concurrently resident in the main memory 706, it is clear that respective components of the main memory 706 are not required to be completely resident in the main memory 706 at all times or even at the same time. In one embodiment, the information processing system 700 utilizes conventional virtual addressing mechanisms to allow programs to behave as if they have access to a large, single storage entity, referred to herein as a computer system memory, instead of access to multiple, smaller storage entities such as the main memory 706 and data storage device 716. Note that the term “computer system memory” is used herein to generically refer to the entire virtual memory of the information processing system 700.

Although only one CPU 704 is illustrated for computer 702, computer systems with multiple CPUs can be used equally effectively. Embodiments of the present invention further incorporate interfaces that each includes separate, fully programmed microprocessors that are used to off-load processing from the CPU 704. Terminal interface 710 is used to directly connect one or more terminals 720 to computer 702 to provide a user interface to the information processing system 700. These terminals 720, which are able to be non-intelligent or fully programmable workstations, are used to allow system administrators and users to communicate with the information processing system 700. The terminal 720 also may comprise a user interface and peripheral devices that are connected to computer 702 and are controlled by terminal interface hardware included in the terminal interface 710 that includes video adapters and interfaces for keyboards, pointing devices, and the like.

An operating system (not shown) included in the main memory 706 is a suitable multitasking operating system such as the Linux, UNIX, Windows XP, and Windows Server 2007 operating system. Embodiments of the present invention are able to use any other suitable operating system. Some embodiments of the present invention utilize architectures, such as an object oriented framework mechanism, that allows instructions of the components of operating system (not shown) to be executed on any processor located within the information processing system 700.

The network adapter hardware 712 is used to provide an interface to the packet data network 102 and the circuit services network 104. Embodiments of the present invention are able to be adapted to work with any data communications connections including present day analog and/or digital techniques or via a future networking mechanism.

Although the exemplary embodiments of the present invention are described in the context of a fully functional computer system, those skilled in the art will appreciate that embodiments are capable of being distributed as a program product via CD, for example, CD 718, floppy-disk, or other form of recordable media, or via any type of electronic transmission mechanism.

Wireless Device

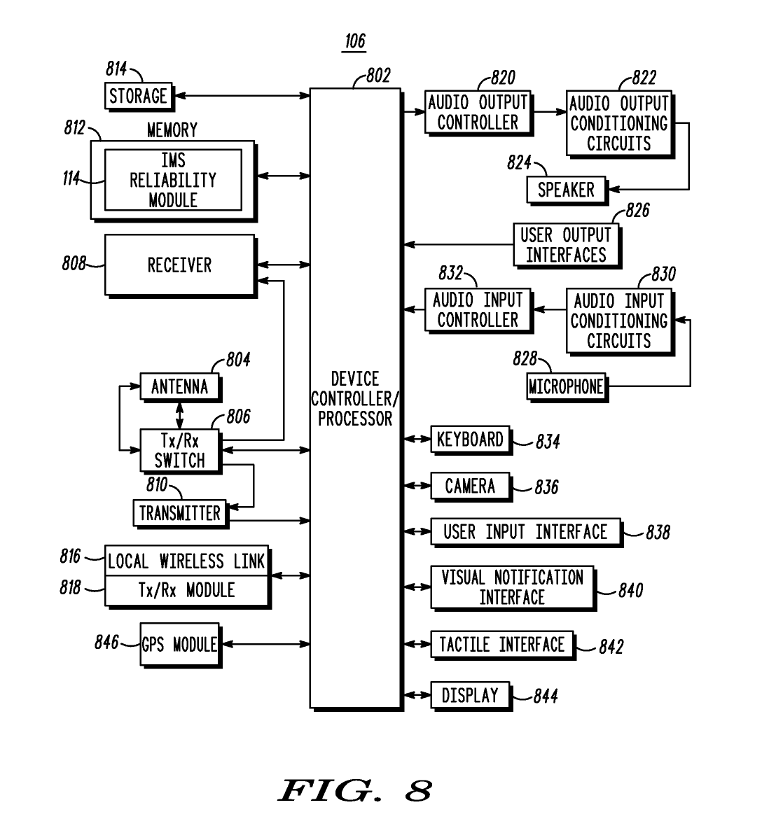

FIG. 8 is a block diagram illustrating a more detailed view of the wireless device 106. In one embodiment, the wireless device 106 is a dual mode device capable of communicating on either the packet data network 102 or the circuit services network 104. The wireless device 106 operates under the control of a device controller/processor 802 that controls the sending and receiving of wireless communication signals. In receive mode, the device controller 802 electrically couples an antenna 804 through a transmit/receive switch 806 to a receiver 808. The receiver 808 decodes the received signals and provides those decoded signals to the device controller 802.

In transmit mode, the device controller 802 electrically couples the antenna 804, through the transmit/receive switch 806, to a transmitter 810. The device controller 802 operates the transmitter and receiver according to instructions stored in a memory 812. These instructions include, for example, a neighbor cell measurement-scheduling algorithm. The memory 812 also includes the IMS reliability module 114 for detecting the availability of an S-CSCF, such as S-CSCF 210, as discussed above.

The wireless device 106 also includes non-volatile storage memory 814 for storing, for example, an application waiting to be executed (not shown) on the wireless device 106. The wireless device 106, in this example, also includes an optional local wireless link 816 that allows the wireless device 106 to directly communicate with another wireless device without using the wireless network 102. The optional local wireless link 816, for example, is provided by Bluetooth, Infrared Data Access (IrDA) technologies, or the like. The optional local wireless link 816 also includes a local wireless link transmit/receive module 818 that allows the wireless device 106 to directly communicate with another wireless communication device.

The wireless device 106 of FIG. 8 further includes an audio output controller 820 that receives decoded audio output signals from the receiver 808 or the local wireless link transmit/receive module 818. The audio controller 820 sends the received decoded audio signals to the audio output conditioning circuits 822 that perform various conditioning functions. For example, the audio output conditioning circuits 822 may reduce noise or amplify the signal. A speaker 824 receives the conditioned audio signals and allows audio output for listening by a user. The audio output controller 820, audio output conditioning circuits 822, and the speaker 824 also allow for an audible alert to be generated notifying the user of a missed call, received messages, or the like. The wireless device 106 further includes additional user output interfaces 826, for example, a head phone jack (not shown) or a hands-free speaker (not shown).

The wireless device 106 also includes a microphone 828 for allowing a user to input audio signals into the wireless device 106. Sound waves are received by the microphone 828 and are converted into an electrical audio signal. Audio input conditioning circuits 840 receive the audio signal and perform various conditioning functions on the audio signal, for example, noise reduction. An audio input controller 832 receives the conditioned audio signal and sends a representation of the audio signal to the device controller 802.

The wireless device 106 also comprises a keyboard 834 for allowing a user to enter information into the wireless device 106. The wireless device 106 further comprises a camera 836 for allowing a user to capture still images or video images into memory 812. Furthermore, the wireless device 106 includes additional user input interfaces 838, for example, touch screen technology (not shown), a joystick (not shown), or a scroll wheel (not shown). In one embodiment, a peripheral interface (not shown) is also included for allowing the connection of a data cable to the wireless device 106. In one embodiment of the present invention, the connection of a data cable allows the wireless device 106 to be connected to a computer or a printer.

A visual notification (or indication) interface 840 is also included on the wireless device 106 for rendering a visual notification (or visual indication), for example, a sequence of colored lights on the display 844 or flashing one ore more LEDs (not shown), to the user of the wireless device 106. For example, a received multimedia message may include a sequence of colored lights to be displayed to the user as part of the message. Alternatively, the visual notification interface 840 can be used as an alert by displaying a sequence of colored lights or a single flashing light on the display 844 or LEDs (not shown) when the wireless device 106 receives a message, or the user missed a call.

The wireless device 106 also includes a tactile interface 842 for delivering a vibrating media component, tactile alert, or the like. For example, a multimedia message received by the wireless device 106 may include a video media component that provides a vibration during playback of the multimedia message. The tactile interface 842, in one embodiment, is used during a silent mode of the wireless device 106 to alert the user of an incoming call or message, a missed call, or the like. The tactile interface 842 allows this vibration to occur, for example, through a vibrating motor or the like.

The wireless device 106 also includes a display 844 for displaying information to the user of the wireless device 106. An optional Global Positioning System (GPS) module 846 is used to determine the location and/or velocity information of the wireless device 106. This module 846 uses the GPS satellite system to determine the location and/or velocity of the wireless device 106. Alternative to the GPS module 846, the wireless device 106 may include alternative modules for determining the location and/or velocity of wireless device 106, for example, using cell tower triangulation and assisted GPS, using accelerometers in the wireless device 106, and other devices and techniques as are known to those of ordinary skill in the art.

Detection of an Availability of an S-CSCF by a P-CSCF

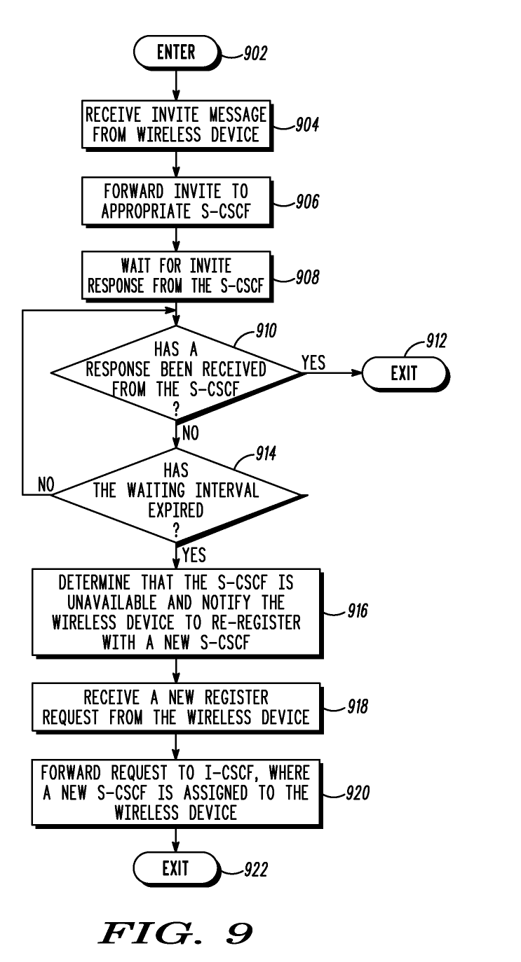

FIG. 9 is an operational flow diagram illustrating a process of the P-CSCF 206 detecting an availability of the S-CSCF 210 according to an embodiment of the present invention. The operational flow diagram of FIG. 9 begins at step 902 and flows directly to step 904. The P-CSCF 206, at step 904, receives an INVITE message from a wireless device 106. The P-CSCF, at step 906, forwards the INVITE message to the S-CSCF 210, based on route header information included in the INVITE message. The P-CSCF 206, at step 908, waits for an INVITE response from the S-CSCF 210.

The P-CSCF 206, at step 910, determines if a response has been received from the S-CSCF 210. If the result of this determination is positive, the control flow exits at step 912. If the result of this determination is negative, the P-CSCF 206, at step 914, determines if a response waiting interval has expired. If the result of this determination is negative, the P-CSCF continues to wait for a response and returns to step 910. If the result of this determination is positive, the IMS reliability module 216 associated with P-CSCF 216, at step 916, determines that the S-CSCF is unavailable and notifies the wireless device 106 to re-register with a new S-CSCF. The P-CSCF, at step 918, receives a REGISTER request from the wireless device 106 and forwards this request, at step 920, to the I-CSCF 208, wherein a new S-CSCF is assigned to the wireless device 106. The control flow then exits at step 922.

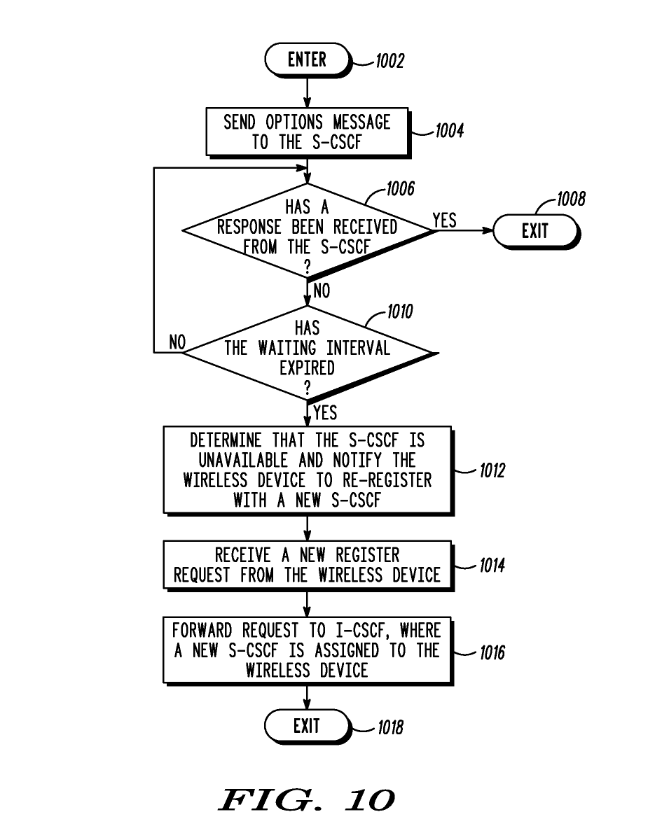

FIG. 10 is an operational flow diagram illustrating a process of the P-CSCF 206 detecting the availability of the S-CSCF 210 according to another embodiment of the present invention. The operational flow diagram of FIG. 10 begins at step 1002 and flows directly to step 1004. The P-CSCF 206, at step 904, sends an OPTIONS message to the S-CSCF 210. The P-CSCF 206, at step 1006, determines if a response has been received from the S-CSCF 210. If the result of this determination is positive, the control flow exits at step 1008. If the result of this determination is negative, the P-CSCF 206, at step 1010, determines if a response waiting interval has expired. If the result of this determination is negative, the P-CSCF 206 continues to wait for a response and returns to step 1006. If the result of this determination is positive, the IMS reliability module 216 associated with P-CSCF 206, at step 1012, determines that the S-CSCF 210 is unavailable and notifies the wireless device 106 to re-register with a new S-CSCF. The P-CSCF 206, at step 1014, receives a REGISTER request from the wireless device 106 and forwards this request, at step 1016, to the I-CSCF 208, wherein a new S-CSCF is assigned to the wireless device 106. The control flow then exits at step 1018.

Detection of an Availability of an S-CSCF by a Wireless Device

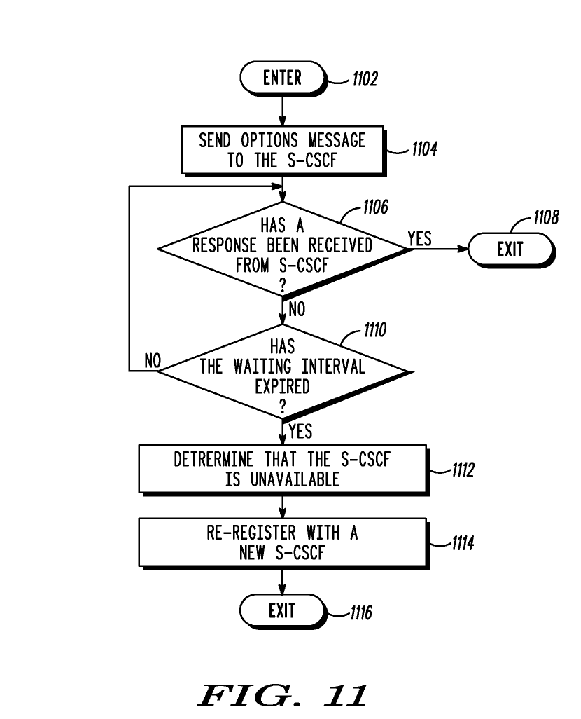

FIG. 11 is an operational flow diagram illustrating a process of the wireless device 106 detecting an availability of the S-CSCF 210, according to another embodiment of the present invention. The operational flow diagram of FIG. 11 begins at step 1102 and flows directly to step 1104. The wireless device 106, at step 904, sends an OPTIONS message to the S-CSCF 210. The wireless device 106, at step 1106, determines if a response has been received from the S-CSCF 210. If the result of this determination is positive, the control flow exits at step 1108. If the result of this determination is negative, the wireless device 106, at step 1110, determines if an “S-CSCF Unavailable” message has been received from the P-CSCF 206. If the result of this determination is negative, the wireless device 106 continues to wait for a response and returns to step 1106. If the result of this determination is positive, the MS reliability module 114 associated with the wireless device 106, at step 1112, determines that the S-CSCF 210 is unavailable and the wireless device, at step 1114, re-registers with a new S-CSCF. The control flow then exits at step 1116.

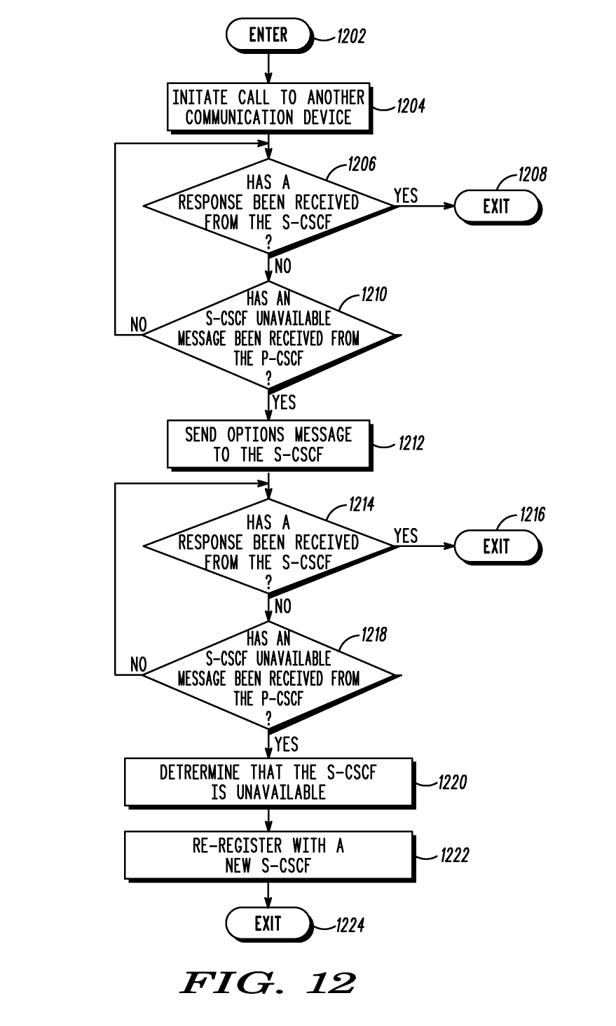

FIG. 12 is an operational flow diagram illustrating a process of the wireless device 106 detecting an availability of the S-CSCF 210 according to another embodiment of the present invention. The operational flow diagram of FIG. 12 begins at step 1202 and flows directly to step 1204. The wireless device 106, at step 1204, initiates a call to another device by sending an INVITE message to the S-CSCF 210. The wireless device, at step 1206, determines if a response has been received from the S-CSCF 210. If the result of this determination is positive, the control flow exits at step 1208. If the result of this determination is negative, the wireless device 106, at step 1210, determines if an “S-CSCF Unavailable” message has been received from the P-CSCF 206 in response to the INVITE message. If the result of this determination is negative, the wireless device 106 continues to wait for a response and returns to step 1206.

If the result of this determination is positive, the wireless device 106, at step 1212, sends an OPTIONS message to the S-CSCF 210. The wireless device, at step 1214, determines if a response to the OPTIONS message has been received from the S-CSCF 210. If the result of this determination is positive, the control flow exits at step 1216. If the result of this determination is negative, the wireless device 106, at step 1218, determines if an “S-CSCF Unavailable” message has been received from the P-CSCF 206 in response to the OPTIONS message. If the result of this determination is negative, the wireless device 106 continues to wait for a response and returns to step 1214. If the result of this determination is positive, the IMS reliability module 114, at step 1220, determines that the S-CSCF 210 is unavailable and the wireless device, at step 1222, re-registers with a new S-CSCF. The control flow then exits at step 1224.

Non-Limiting Examples

The foregoing embodiments of the present invention are advantageous because they provide dynamic optimization of the resources available to wireless communication information to wireless communication devices using unicast or broadcast/multicast communication modes. Information can be wireless communicated to a wireless communication device in a more timely manner thereby optimizing network resources.

Although specific embodiments of the invention have been disclosed, those having ordinary skill in the art will understand that changes can be made to the specific embodiments without departing from the spirit and scope of the invention. The scope of the invention is not to be restricted, therefore, to the specific embodiments, and it is intended that the appended claims cover any and all such applications, modifications, and embodiments within the scope of the present invention.

What is claimed is:

1. A method for providing reliability in an Internet Protocol (“IP”) Multimedia Subsystem Network, the method with an information processing system including a Proxy Call Session Control Function (“P-CSCF”), the method comprising:
monitoring a Serving Call Session Control Function (“S-CSCF”) for its availability;
determining, based on the monitoring, that the S-CSCF is unavailable; and
notifying a wireless device registered with the S-CSCF that the S-CSCF is unavailable.

2. The method of claim 1, wherein the monitoring further comprises:
forwarding a communication request from a wireless device to the S-CSCF; and
determining that the S-CSCF has not responded to the communication request.

3. The method of claim 2, wherein the determining that the S-CSCF is unavailable further comprises:
determining, based on the S-CSCF not responding to the communication request, that the S-CSCF is unavailable.

4. The method of claim 2, wherein the communication request is an INVITE request.

5. The method of claim 1, wherein the notifying further comprises notifying the wireless device to re-register with a new S-CSCF.

6. The method of claim 1, wherein the monitoring further comprises:
sending a Session Initiation Protocol (“SIP”) message at given intervals to the S-CSCF; and
determining that the S-CSCF has not responded to the SIP message.

7. The method of claim 6, wherein the determining that the S-CSCF is unavailable further comprises determining, based on the S-CSCF not responding to the SIP message, that the S-CSCF is unavailable.

8. The method of claim 1, further comprising automatically re-registering the wireless device with a new S-CSCF in response to the determining that the S-CSCF is unavailable.

9. A method for providing reliability in an IP multimedia subsystem network, the method on a wireless device, the method comprising:
monitoring an S-CSCF for its availability;
determining, based on the monitoring, that the S-CSCF is unavailable; and
registering with a new S-CSCF based on the determining that the S-CSCF is unavailable.

10. The method of claim 9, wherein the monitoring further comprises sending a SIP message to the S-CSCF via a P-CSCF.

11. The method of claim 10, wherein the determining that the S-CSCF is unavailable further comprises receiving a notification from the P-CSCF, in response to the S-CSCF failing to respond to the SIP message, that the S-CSCF is unavailable.

12. The method of claim 9, wherein the monitoring further comprises:
sending a communication request the S-CSCF via a P-CSCF;
determining that the S-CSCF failed to respond to the communication request within a given interval; and
sending, in response to determining that the S-CSCF failed to respond to the communication request, a SIP message to the S-CSCF via the P-CSCF.

13. The method of claim 12, wherein the determining that the S-CSCF is unavailable further comprises receiving a notification from the P-CSCF, in response to the S-CSCF failing to respond to the SIP message, that the S-CSCF is unavailable.

14. An information processing system for providing reliability in an IP multimedia subsystem network, the information processing system comprising:
a memory;
a processor communicatively coupled to the memory; and
an IP multimedia subsystem reliability module associated with the memory and the processor, wherein the IP multimedia subsystem reliability module is configured to monitor an S-CSCF for its availability, determine, based on the monitoring, that the S-CSCF is unavailable, and notify a wireless device registered with the S-CSCF that the S-CSCF is unavailable.

15. The information processing system of claim 14, wherein the IP multimedia subsystem reliability module is configured to determine that an S-CSCF is unavailable by forwarding a communication request from a wireless device to the S-CSCF and determining that the S-CSCF has not responded to the communication request.

16. The information processing system of claim 15, wherein the communication request is an INVITE request.

17. The information processing system of claim 14, wherein the notifying further comprises notifying the wireless device to re-register with a new S-CSCF.

18. The information processing system of claim 14, wherein the IP multimedia subsystem reliability module is configured to determine that an S-CSCF is unavailable by sending a SIP message at given intervals to the S-CSCF and determining that the S-CSCF has not responded to the SIP message.

19. The information processing system of claim 14, wherein the IP multimedia subsystem reliability module is further configured to automatically re-register the wireless device with a new S-CSCF in response to the determining that the S-CSCF is unavailable.

20. The information processing system of claim 14, wherein a Proxy Call Session Control Function (“P-CSCF”) comprises the IP multimedia subsystem reliability module.
